(19) United States
(12) Patent Application Publication
(10) Pub. No.: US 2026/0081188 A1
(43) Pub. Date: Mar. 19, 2026

(54) SEPARATOR USED IN FUEL CELL, AND FUEL CELL

(71) Applicant: TOYOTA JIDOSHA KABUSHIKI KAISHA, Toyota-shi Aichi-ken (JP)

(72) Inventors: Tohru ODA, Toyota-shi Aichi-ken (JP); Kohei SAKURAI, Toyota-shi Aichi-ken (JP); Ryo AKAGAWA, Okazaki-shi Aichi-ken (JP); Jin ITO, Nagoya-shi Aichi-ken (JP); Kosuke KURUSHIMA, Toyota-shi Aichi-ken (JP)

(73) Assignee: TOYOTA JIDOSHA KABUSHIKI KAISHA, Toyota-shi Aichi-ken (JP)

(21) Appl. No.: 19/268,056

(22) Filed: Jul. 14, 2025

(30) Foreign Application Priority Data
Sep. 17, 2024 (JP) 2024-160280

(51) Int. Cl. H01M 8/0258; H01M 8/0232; H01M 8/04119

(52) U.S. Cl. CPC H01M 8/0258; H01M 8/0232; H01M 8/04171

(57) ABSTRACT

A separator used in a fuel cell includes: a supply manifold hole for fuel gas; an exhaust manifold hole for the fuel gas; and a fuel gas flow path system causing the fuel gas to flow through an electricity generation portion of the fuel cell, the fuel gas flow path system including a first flow path portion directing the fuel gas from the supply manifold hole to the electricity generation portion, a second flow path portion facing the electricity generation portion and supplying the fuel gas to the electricity generation portion, and a third flow path portion directing the fuel gas from the electricity generation portion to the exhaust manifold hole. The third flow path portion includes a low-hydrophilicity flow path disposed at the vicinity of the exhaust manifold hole and includes a low-hydrophilicity surface.

### CROSS-REFERENCE TO RELATED APPLICATION

This application claims priority to Japanese Patent Application No. 2024-160280 filed on Sep. 17, 2024. The disclosure of the above-identified application, including the specification, drawings, and claims, is incorporated by reference herein in its entirety.

### BACKGROUND

### 1. Technical Field

The present disclosure relates to a separator that is used in a fuel cell, and a fuel cell.

### 2. Description of Related Art

For example, a fuel cell such as a polymer electrolyte fuel cell (PEFC) is configured such that an electricity generation portion is laminated via separators. The electricity generation portion is a membrane electrode and gas diffusion layer assembly (MEGA) in which a polymer electrolyte membrane is sandwiched between an anode and a cathode.

On a separator on the anode side of the MEGA, grooves are formed as a supply manifold hole for fuel gas through which the fuel gas is supplied to the MEGA, an exhaust manifold hole for the fuel gas, and an anode gas flow path that guides anode gas to a gas diffusion layer on the anode side.

At the time of the operation of the fuel cell, water is sometimes produced in the MEGA. For example, there is a technology in which a hydrophilicity treatment is performed to a fuel gas flow path for effectively exhausting the water generated due to the production or the like in the anode and the water is exhausted from the exhaust manifold hole together with the fuel gas (Japanese Unexamined Patent Application Publication No. 2008-112721 (JP 2008-112721 A)).

### SUMMARY

However, for example, at the time of the stop of the operation, the produced water sometimes flows backward into the fuel gas flow path from the vicinity of the exhaust manifold hole for the fuel gas to the MEGA side, due to capillary action or the like. When the MEGA is exposed to the produced water in such a state, the decrease in the electricity generation performance of the fuel cell is sometimes caused.

The present specification provides a fuel cell that makes it possible to restrain the backward flow of water (produced water) from the fuel-gas exhaust manifold hole of the separator to the fuel gas flow path in the fuel cell.

A technology disclosed in the present specification is embodied as a separator that is used in a fuel cell. The separator includes: a supply manifold hole for fuel gas; an exhaust manifold hole for the fuel gas; and a fuel gas flow path system that causes the fuel gas to flow through an electricity generation portion of the fuel cell, the fuel gas flow path system including a first flow path portion that directs the fuel gas from the supply manifold hole to the electricity generation portion, a second flow path portion that faces the electricity generation portion and that supplies the fuel gas to the electricity generation portion, and a third flow path portion that directs the fuel gas from the electricity generation portion to the exhaust manifold hole. The third flow path portion includes a low-hydrophilicity flow path that is disposed at the vicinity of the exhaust manifold hole and that includes a low-hydrophilicity surface lower in hydrophilicity than a surface of another adjacent flow path of the fuel gas flow path system.

With the separator, when the water around the exhaust manifold hole reaches the low-hydrophilicity flow path, the movement of the water due to the capillary action is curbed on the low-hydrophilicity flow path, by the low-hydrophilicity surface of the low-hydrophilicity flow path. Therefore, for example, at the time of the stop of the fuel cell, the backward flow phenomenon in which the water moves toward the electricity generation portion is restrained or avoided. On the other hand, on flow paths other than the low-hydrophilicity flow path, the exhaust of water is promoted, for example, at the time of the operation of the fuel cell. Therefore, the exposure of the separator and the electricity generation portion to water is restrained or avoided at both the time of the operation and the time of the stop.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing the relation between a MEGA and a separator of a fuel cell;

FIG. 2 is a diagram showing a cross-section of the MEGA; and

FIG. 3 is a diagram showing a plane of a fuel gas flow path system of the separator that corresponds to the MEGA.

### DETAILED DESCRIPTION OF EMBODIMENTS

A separator disclosed in the present specification is used in a fuel cell, and includes a supply manifold hole for fuel gas; an exhaust manifold hole for the fuel gas; and a fuel gas flow path system that causes the fuel gas to flow through an electricity generation portion of the fuel cell, the fuel gas flow path system including a first flow path portion that directs the fuel gas from the supply manifold hole to the electricity generation portion, a second flow path portion that faces the electricity generation portion and that supplies the fuel gas to the electricity generation portion, and a third flow path portion that directs the fuel gas from the electricity generation portion to the exhaust manifold hole, in which the third flow path portion can include a low-hydrophilicity flow path that is disposed at the vicinity of the exhaust manifold hole and that includes a low-hydrophilicity surface lower in hydrophilicity than a surface of another adjacent flow path of the fuel gas flow path system.

In another aspect of the separator, each of the first flow path portion, the second flow path portion, and the third flow path portion of the separator that are other than the low-hydrophilicity flow path may include a surface to which a hydrophilicity treatment has been performed. In this aspect, the low-hydrophilicity flow path is provided with the low-hydrophilicity surface, because the hydrophilicity treatment has not been performed. The separator is easily produced at low cost.

Another aspect of the separator may include the exhaust manifold hole at a position corresponding to the vicinity of one corner portion at a gravity-directional lower end of the separator in the fuel cell, and may include the low-hydrophilicity flow path at a position corresponding to the vicinity of a gravity-directional lower end of the third flow path portion. In this aspect, since the low-hydrophilicity flow path is provided on the gravity-directional lower end side, water is concentrated at the low-hydrophilicity flow path on the gravity-directional lower end side, by gravity, and therefore, the backward flow of water can be more effectively restrained or avoided.

Another aspect of the separator may include a base material made of stainless steel. From the base material made of stainless steel, Fe ions are sometimes eluted. In this aspect, even when Fe ions are eluted from stainless steel, the water containing Fe ions is restrained from reaching the electricity generation portion, particularly, an electrolyte membrane. Therefore, even when the stainless-steel base material obtained at low cost is used, it is possible to effectively restrain the electrolyte membrane from deteriorating due to Fenton reaction of Fe ions.

A fuel cell disclosed in the present specification may be a fuel cell that includes the separator in one of the above aspects. With the fuel cell, the exhaust of water is promoted at the time of the operation of the fuel cell, and the backward flow of water from the exhaust manifold hole is restrained or avoided at the time of the stop of the fuel cell. As a result, the electricity generation portion is restrained from deteriorating due to water or components that can be contained in water.

In the present specification, the fuel cell is not particularly limited. For example, a polymer electrolyte fuel cell (PEFC) can be desirable. Further, for the fuel cell, various cooling techniques including a cooling with a liquid refrigerant such as water can be adopted.

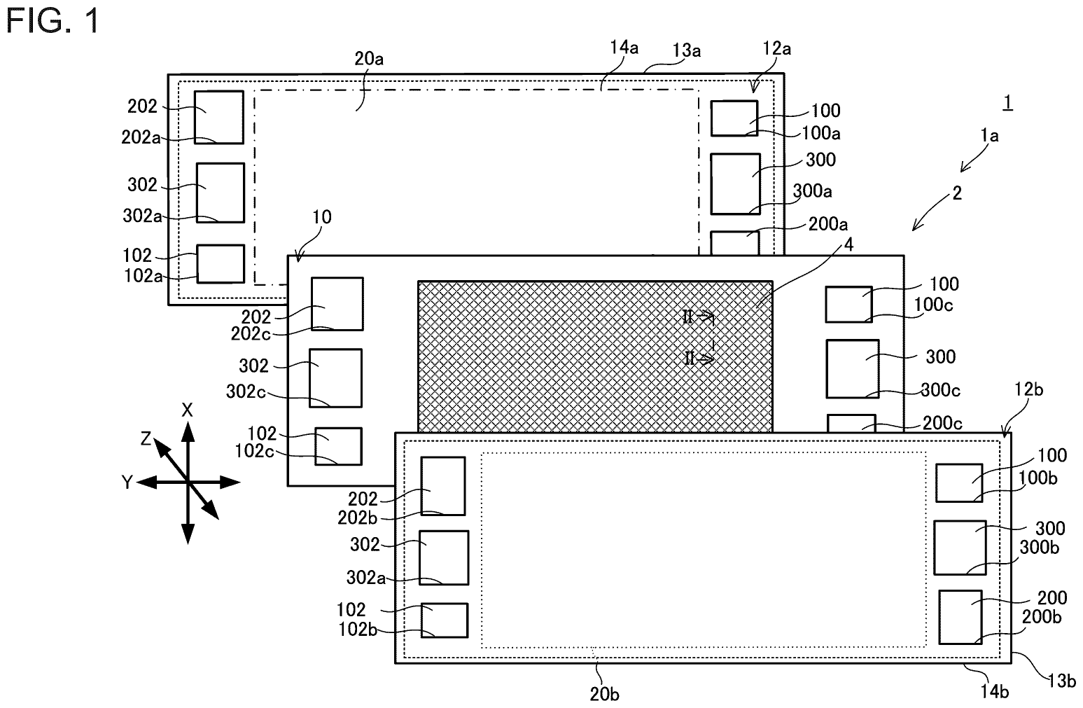

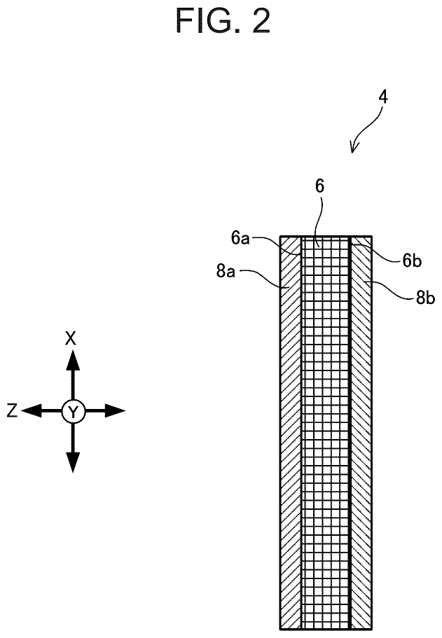

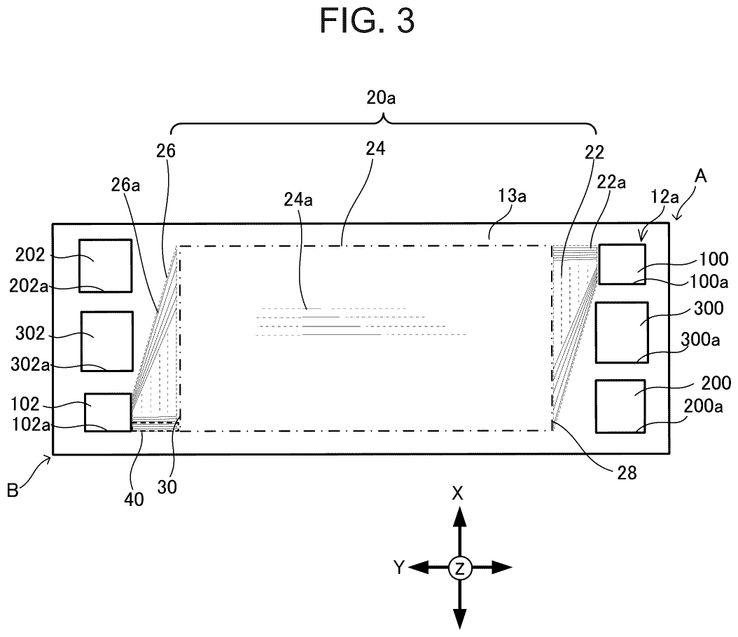

The fuel cell disclosed in the present disclosure will be described below with reference to the drawing when appropriate. FIG. 1 shows an exploded explanatory diagram of an MEA-containing resin assembly (also referred to as merely an assembly, hereinafter) 4 that constitutes a cell 2 of a fuel cell that is a PEFC, and two separators 12a, 12b that sandwich the MEA-containing resin assembly 4. FIG. 2 shows an enlarged diagram of a cross-section along line II-II in FIG. 1. FIG. 3 shows a diagram of the separator 12a as viewed from a plane that opposes a fuel electrode side of the MEA-containing resin assembly 4.

FIG. 1 shows the cell 2 that constitutes the fuel cell 1. The cell 2 includes a membrane electrode and gas diffusion layer assembly (MEGA) 4 and the separators 12a, 12b that abuts on the MEGA 4. In the cell 2, the MEGA 4 and the separators 12a, 12b are laminated along a third direction Z orthogonal to a first direction X that is the gravity direction in FIG. 1. An appropriate number of cells 2 are laminated along the third direction Z, and thereby, a stack 1a is constituted.

As shown in FIG. 2, the MEGA 4 includes a membrane electrode assembly (MEA) 6, and includes gas diffusion layers 8a, 8b that are diffusion layers of fuel gas and oxidant gas, on planes 6a, 6b of the membrane electrode assembly 6, respectively. Although not illustrated, the membrane electrode assembly 6 is assembled so as to sandwich an electrolyte membrane with a fuel electrode and an air electrode.

For example, the electrolyte membrane is an ion-exchange membrane formed of a solid polymer material and having proton conductivity. Each of the fuel electrode and the air electrode is composed of a known material. The gas diffusion layers 8a, 8b are provided for the fuel electrode and air electrode of the MEA 6, respectively. The gas diffusion layers 8a, 8b are formed by an electrically conductive member having gas permeability, as exemplified by a porous carbon body. The MEGA 4 or the MEA 6 is an example of the electricity generation portion in the present specification.

As shown in FIG. 1, the MEGA 4 is held by a frame 10 that encloses the MEGA 4. The frame 10 is a plate-shaped body made of resin, for example, and holds the MEGA 4 at a central opening portion of the frame 10.

For example, the separators 12a, 12b are plate-shaped members that includes stainless-steel base materials 13a, 13b. Electrically conductive layers composed of an electrically conductive material such as carbon are formed on surfaces of the stainless-steel base materials 13a, 13b. A fuel gas flow path system 20a for causing the fuel gas to flow between the separator 12a and the gas diffusion layer 8a is provided on a plane 14a of the separator 12a that faces the fuel electrode side of the MEGA 4. An oxidant gas flow path system 20b for causing the oxidant gas to flow between the separator 12b and the gas diffusion layer 8b is provided on a plane 14b of the separator 12b that faces the oxygen electrode side of the MEGA 4. The fuel gas flow path system 20a and the oxygen gas flow path system 20b will be described later in detail.

Planes of the separators 12a, 12b that do not face the MEGA 4 are joined to separators 12b, 12a of other cells 2 that are adjacently laminated.

The stack 1a in which such cells 2 are laminated includes a fuel gas supply manifold 100 and a fuel gas exhaust manifold 102, for causing hydrogen as the fuel gas to flow through the MEGA 4. Further, the stack 1a includes an oxidant gas supply manifold 200 and an oxidant gas exhaust manifold 202, for causing oxygen or air as the oxidant gas to flow through the MEGA 4. Furthermore, the stack 1a includes a refrigerant supply manifold 300 and a refrigerant exhaust manifold 302, for the flowing of a refrigerant for cooling the cells 2, as exemplified by water.

Corresponding to the manifolds 100, 102, 200, 202, 300, 302, the separator 12a includes a supply manifold hole 100a and an exhaust manifold hole 102a for the fuel gas, a supply manifold hole 200a and an exhaust manifold hole 202a for the oxidant gas, and a supply manifold hole 300a and an exhaust manifold hole 302a for the refrigerant.

Further, corresponding to the manifolds 100, 200, 300, the separator 12b includes manifold holes 100b, 102b, 200b, 202b, 300b, 302b, and the frame 10 includes manifold holes 100c, 102c, 200c, 202c, 300c, 302c.

Next, with reference to FIG. 3, the fuel gas flow path system 20a in the separator 12a will be described. As shown in FIG. 3, the fuel gas flow path system 20a includes a first flow path portion 22 that directs the fuel gas from the supply manifold hole 100a to the MEGA 4, a second flow path portion 24 that faces the MEGA 4 and that supplies the fuel gas to the MEGA 4, and a third flow path portion 26 that directs the fuel gas from the MEGA 4 to the exhaust manifold hole 102a. The fuel gas flow path system 20a is formed, for example, by the bending process of the stainless-steel base material 13a into a concave-convex shape. The flow paths are formed in a concave shape that is opened to the upper side of the sheet plane of the FIG. 3, that is, toward the MEGA 4.

The first flow path portion 22 is formed between the supply manifold hole 100a formed at the vicinity of an upper end portion A of the separator 12a in the gravity direction and one end edge 28 of the MEGA 4 in a second direction Y. The first flow path portion 22 includes a plurality of first flow paths 22a. The first flow paths 22a are formed from the supply manifold hole 100a to the end edge 28 of the MEGA 4. The first flow paths 22a may be arrayed in an arbitrary pattern, so as to be capable of guiding the fuel gas to the MEGA 4. That is, one first flow path 22a may continuously extend to the end edge 28 or the vicinity thereof in an arbitrary pattern, for each of the first flow paths 22a, or the first flow paths 22a may be closely arrayed to the end edge 28 or the vicinity thereof in an arbitrary pattern, so as to be capable of guiding the fuel gas to the MEGA 4.

The second flow path portion 24 is formed so as to face the MEGA 4. The second flow path portion 24 includes a plurality of second flow paths 24a. The second flow paths 24a are formed from the end edge 28 or the vicinity thereof to an end edge 30 or the vicinity thereof. Similarly to the first flow path 22a, the second flow paths 24a are arrayed in an arbitrary pattern such that each second flow path 24a is capable of supplying the fuel gas to the MEGA 4.

The third flow path portion 26 is formed between the end edge 30 of the MEGA 4 and the exhaust manifold hole 102a. The exhaust manifold hole 102a is formed at the vicinity of a corner portion B of a lower end of the separator 12a in the gravity direction. The third flow path portion 26 includes a plurality of third flow paths 26a. The third flow paths 26a are formed from the end edge 30 of the MEGA 4 or the vicinity thereof to an opening rim of the exhaust manifold hole 102a or the vicinity thereof. Typically, the third flow paths 26a are formed in a comb-lobe-like pattern so as to extend from the opening rim of the exhaust manifold hole 102a or the vicinity thereof to the end edge 30 of the MEGA 4. Similarly to the first flow paths 22a, the third flow paths 26a are arrayed in an arbitrary pattern, such that the third flow paths 26a are capable of guiding the fuel gas from the MEGA 4 to the exhaust manifold hole 102a.

The third flow path portion 26 includes a low-hydrophilicity flow path 40 at a part thereof. The low-hydrophilicity flow path 40 is a flow path including a low-hydrophilicity surface lower in hydrophilicity than portions other than the low-hydrophilicity flow path 40, or a part of the flow path. The low-hydrophilicity flow path 40 is constituted by a single or plurality of third flow paths 26a that are included in the third flow path portion 26 and that are closest to a gravity-directional lower end, or a part of the single or plurality of third flow paths 26a. A single low-hydrophilicity flow path 40 may be provided, or a plurality of low-hydrophilicity flow paths 40 may be provided. The low-hydrophilicity flow path 40 may include the low-hydrophilicity surface at least at a part of a flow path range from the vicinity of the opening rim of the exhaust manifold hole 102a of the third flow path portion 26 to the end edge 30 of the MEGA 4. The low-hydrophilicity surface may be formed only at a part of the vicinity of the exhaust manifold hole 102a of the continuous low-hydrophilicity flow path 40.

The low-hydrophilicity flow path 40 restrains the backward flow of water from the exhaust manifold hole 102a. Therefore, the low-hydrophilicity flow path 40 has a lower hydrophilicity than the third flow path portion 26 and/or the second flow path portion 24 of the fuel gas flow path system 20a that is adjacent to the low-hydrophilicity flow path 40.

For example, the contact angle of water on the low-hydrophilicity flow path 40 is smaller than the contact angle of water on the adjacent third flow path portion 26 and/or second flow path portion 24. The contact angle of water on the low-hydrophilicity flow path 40 is more than 70°, 75° or more, 80° or more, 85° or more, or 88° or more, and the contact angle of water on at least a part of the third flow path portion 26 and/or the second flow path portion 24 adjacent to the low-hydrophilicity flow path 40 is 50° or less, 40° or less, 30° or less, or 28° or less.

The contact angle of water can be measured by the following method. As a measurement device, a camera-equipped apparatus that reads the angle of liquid dropped on a test object plane is used. The liquid to be used is pure water (ion-exchange water), the amount of liquid is 0.8 μl to 1.0 μl, and the liquid is dropped on the test object plane by a liquid contact method. After 10 seconds elapses from the drop, the contact angle of the liquid droplet is read by the camera-equipped apparatus. The measurement of the contact angle is performed to the separator 12a in a clean state that makes it possible to accurately measure the contact angle of water on the low-hydrophilicity flow path 40. For example, the measurement is performed within 24 hours after the separator 12a is cleaned by an ordinary method. For maintaining the cleanliness of the surface, the preservation before the measurement is performed in an atmosphere that is cut off from process works, using a case with a lid, a desiccator, or the like. The contact angle is measured as an average value of contact angles at a plurality of spots.

For the low-hydrophilicity flow path 40, in the fuel gas flow path system 20a of the separator 12a, a low-hydrophilicity flow path including a low-hydrophilicity surface lower in hydrophilicity than the surface of the adjacent fuel gas flow path system 20a only needs to be formed at the vicinity of the exhaust manifold hole 102a. Specifically, a hydrophilizing treatment is performed to an electrically conductive membrane of a surface 14 of the stainless-steel base material 13a at a portion other than the low-hydrophilicity flow path 40. Thereby, hydrophilizing and partial non-hydrophilizing of the fuel gas flow path system 20a can be concurrently realized. The electrically conductive layer is formed on the surface of the fuel gas flow path system 20a of the stainless-steel base material 13a. The hydrophilizing treatment is a treatment of increasing hydrophilicity by adding or increasing hydrophilic groups (OH, CHO, COOH, or the like) on the surface of the electrically conductive layer by active oxygens generated by ultraviolet irradiation. For example, the hydrophilizing treatment can be performed by the ultraviolet irradiation in a state where the low-hydrophilicity flow path 40 is shielded by a mask that does not transmit ultraviolet rays. Further, for example, the hydrophilizing treatment can be performed after the formation of the fuel gas flow path system 20a.

The low-hydrophilicity flow path 40 is formed by various methods, other than the inexecution of the hydrophilicity treatment. A person skilled in the art can perform this kind of hydrophilizing treatment, for example, by an ozone treatment, a plasma treatment, or a heat treatment.

On the other separator 12b, a known oxidant gas flow path system can be provided as the oxidant gas flow path system 20b. The stack 1a in which the cells 2 including the separators 12a, 12b are laminated can be provided as the fuel cell 1 that is assembled with other known elements.

With the above-described separator 12a, the backward flow of water (produced water) in the fuel electrode of the MEGA 4 is restrained or avoided, and therefore, the inconvenience due to the exposure of the separator and the MEGA 4, particularly, an electrolyte, to water is restrained or avoided.

In the above-described separator 12a, various modifications in separators for known fuel cells can be applied as long as the effect of the low-hydrophilicity flow path 40 is not hindered. For example, the low-hydrophilicity surface of the low-hydrophilicity flow path 40 may be formed by adding a layer containing a water-repelling compound such as silicon resin and fluorine resin, or may be formed by adding a fine concave-convex shape having water repellency. Further, the separator 12a includes the stainless-steel base material 13a, but without being limited to this, a base material containing a known resin material can be used. Further, the separator 12a can include various intermediate layers, other than the electrically conductive layer.

In the disclosure of the specification, the following aspects are included.
[1] A separator that is used in a fuel cell, the separator comprising:
   a supply manifold hole for fuel gas;
   an exhaust manifold hole for the fuel gas; and
   a fuel gas flow path system that causes the fuel gas to flow through an electricity generation portion of the fuel cell, the fuel gas flow path system including
      a first flow path portion that directs the fuel gas from the supply manifold hole to the electricity generation portion,
      a second flow path portion that faces the electricity generation portion and that supplies the fuel gas to the electricity generation portion, and
      a third flow path portion that directs the fuel gas from the electricity generation portion to the exhaust manifold hole, wherein
   the third flow path portion includes a low-hydrophilicity flow path that is disposed at a vicinity of the exhaust manifold hole and that includes a low-hydrophilicity surface lower in hydrophilicity than a surface of another adjacent flow path of the fuel gas flow path system.
[2] The separator according to [1], wherein each of the first flow path portion, the second flow path portion, and the third flow path portion of the separator that are other than the low-hydrophilicity flow path has a surface to which a hydrophilicity treatment has been performed.
[3] The separator according to [1] or [2], wherein the separator includes the exhaust manifold hole at a position corresponding to a vicinity of one corner portion at a gravity-directional lower end of the separator in the fuel cell, and includes the low-hydrophilicity flow path at a position corresponding to a vicinity of a gravity-directional lower end of the third flow path portion.
[4] The separator according to any one of [1] to [3], wherein the separator includes a base material made of stainless steel.
[5] A fuel cell comprising the separator according to any one of [1] to [4].
[6] A method of producing a separator that is used in a fuel cell, the separator including a supply manifold hole for fuel gas, an exhaust manifold hole for the fuel gas, and a fuel gas flow path system that causes the fuel gas to flow through an electricity generation portion of the fuel cell, the fuel gas flow path system including a first flow path portion that directs the fuel gas from the supply manifold hole to the electricity generation portion, a second flow path portion that faces the electricity generation portion and that supplies the fuel gas to the electricity generation portion, and a third flow path portion that directs the fuel gas from the electricity generation portion to the exhaust manifold hole, the method comprising:
preparing the separator; and
forming a low-hydrophilicity flow path including a low-hydrophilicity surface lower in hydrophilicity than a surface of the adjacent fuel gas flow path system, at a vicinity of the exhaust manifold hole of the third flow path portion, in the flow path system of the separator.
[7] The method according to [6], wherein the forming the low-hydrophilicity flow path is performing a hydrophilizing treatment to the surface of the fuel gas flow path system in a state where a range corresponding to the low-hydrophilicity flow path is shielded.
[8] The method according to [6], wherein the hydrophilizing treatment includes ultraviolet irradiation.

The embodiments have been described above. The embodiments are just examples, and do not limit the scope of the claims. The technology described in the claims includes various modifications and alterations of the above-described specific examples. Technical elements described in the present specification or the drawings exert technical utility independently or by various combinations, and are not limited to combinations described in the claims at the time of the filing. Further, technologies exemplified in the present specification or the drawings concurrently achieve a plurality of purposes, and have technical utility simply by achieving one of the purposes.

What is claimed is:

1. A separator that is used in a fuel cell, the separator comprising:
a supply manifold hole for fuel gas;
an exhaust manifold hole for the fuel gas; and
a fuel gas flow path system that causes the fuel gas to flow through an electricity generation portion of the fuel cell, the fuel gas flow path system including
a first flow path portion that directs the fuel gas from the supply manifold hole to the electricity generation portion,
a second flow path portion that faces the electricity generation portion and that supplies the fuel gas to the electricity generation portion, and
a third flow path portion that directs the fuel gas from the electricity generation portion to the exhaust manifold hole, wherein
the third flow path portion includes a low-hydrophilicity flow path that is disposed at a vicinity of the exhaust manifold hole and includes a low-hydrophilicity surface lower in hydrophilicity than a surface of another adjacent flow path of the fuel gas flow path system.

2. The separator according to claim 1, wherein each of the first flow path portion, the second flow path portion, and the third flow path portion of the separator that are other than the low-hydrophilicity flow path has a surface to which a hydrophilicity treatment has been performed.

3. The separator according to claim 2, wherein the separator includes the exhaust manifold hole at a position corresponding to a vicinity of one corner portion at a gravity-directional lower end of the separator in the fuel cell, and includes the low-hydrophilicity flow path at a position corresponding to a vicinity of a gravity-directional lower end of the third flow path portion.

4. The separator according to claim 3, wherein the separator includes a base material made of stainless steel.

5. A fuel cell comprising the separator according to claim 1.
